(19) United States
(12) Patent Application Publication
(10) Pub. No.: US 2011/0188252 A1
(43) Pub. Date: Aug. 4, 2011

(54) Lamp with cable connector assemblies

(76) Inventor: Benny Lin, Wugu Hsiang (TW)

(21) Appl. No.: 12/661,288

(22) Filed: Mar. 15, 2010

(30) Foreign Application Priority Data
Feb. 3, 2010 (TW) 099202166

(51) Int. Cl. F21V 29/00

(52) U.S. Cl. 362/294

(57) ABSTRACT

A lamp has a casing, a heat sink, a thermal tape, an LED module, two cables, a convex lens and a mounting collar. The heat sink, thermal tape and LED module are mounted in the casing. The cables are connected to the LED module and each cable has a stationary cable section, a detachable cable section and a cable connector assembly. The cable connector assembly is mounted between the stationary and detachable cable sections and selectively detaches the detachable cable section from the stationary cable section. The convex lens and mounted collar are mounted in the casing. The cable connector assembly facilitates the replacement of the LED module.

### BACKGROUND OF THE INVENTION

1. Field of the Invention

The present invention relates to a lamp, and more particularly to a lamp that has LED module and cable connector assemblies, facilitates the replacement of the LED module and lowers a material cost.

2. Description of Related Art

Currently widely used incandescent lamps are gradually being replaced by light emitting diodes (LED) for energy saving and environmental protection purposes because of comparatively lower power consumption and longer lifespan of the LEDs.

A conventional LED lamp has a casing, a shade, a heat sink, a fan and an LED module. The casing has a through hole defined therethrough. The shade is mounted on and covers the casing. The heat sink and fan are mounted in the casing by bolts. The LED module is mounted on the heat sink with a light emitting surface facing the shade. The LED module has cables connected securely thereto and each cable has one end extending out of the through hole of the casing for connecting to an external power source.

However, when the LED module is replaced, the cables securely mounted on the LED module are also replaced even though they are still durable and workable, which is uneconomical and increases the cost of the LED lamp. Furthermore, installing a new LED module needs cables to be extended from inside to outside of the casing. However, the heat sink and fan in the casing occupying internal space of the casing need to be detached before installation of the cables and re-attached after the installation, which complicates the replacement of LED module and wastes time.

To overcome the shortcomings, the present invention provides a lamp with cable connector assemblies to mitigate or obviate the aforementioned problems.

### SUMMARY OF THE INVENTION

The main objective of the invention is to provide a lamp that has an LED module and cable connector assemblies, facilitates the replacement of the LED module and lowers a material cost.

A lamp in accordance with the present invention has a casing, a heat sink, a thermal tape, an LED module, two cables, a convex lens and a mounting collar. The heat sink, thermal tape and LED module are mounted in the casing. The cables are connected to the LED module and each cable has a stationary cable section, a detachable cable section and a cable connector assembly. The cable connector assembly is mounted between the stationary and detachable cable sections and selectively detaches the detachable cable section from the stationary cable section. The convex lens and mounted collar are mounted in the casing. The cable connector assembly facilitates the replacement of the LED module.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a lamp with cable connector assemblies in accordance with the present invention;

FIG. 2 is an exploded perspective view of the lamp in FIG. 1; and

FIG. 3 is a side view in partial section of the lamp in FIG. 1.

### DETAILED DESCRIPTION OF THE PREFERRED EMBODIMENT

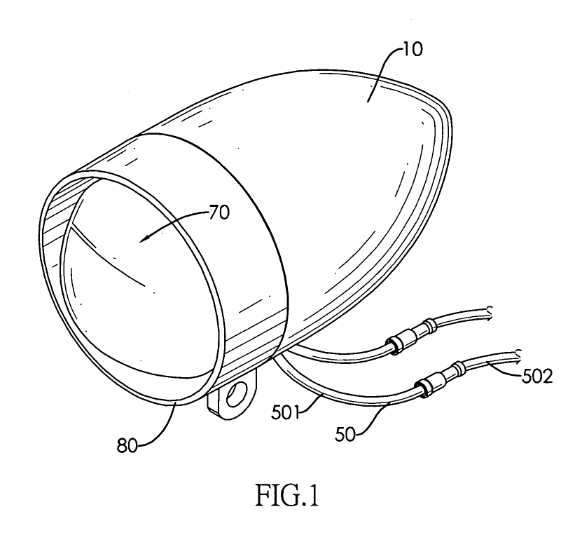

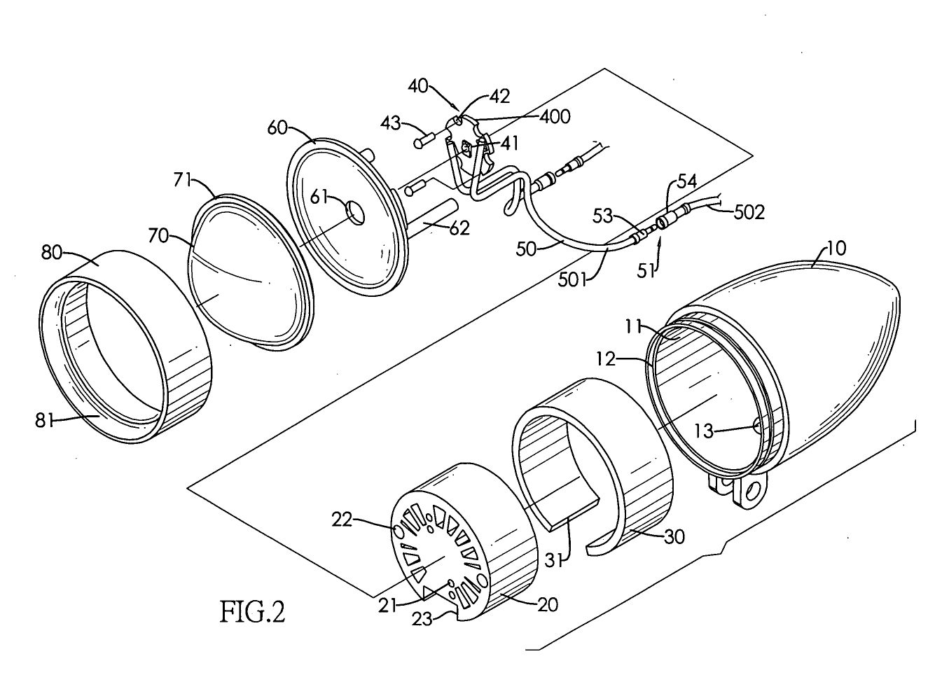

With reference to FIGS. 1 and 2, a lamp in accordance with the present invention comprises a casing (10), a heat sink (20), a thermal tape (30), an LED module (40), two cables (50), a reflector (60), a convex lens (70) and a mounting collar (80).

The casing (10) has a chamber (11), a front opening (12) and a cable outlet hole (13). The chamber (11) is defined in the casing (10) and has an inner surface. The front opening (12) is defined through the casing (10) and communicates with the chamber (11). The cable outlet hole (13) is defined through the casing (10) and communicates with the chamber (11).

The heat sink (20) is mounted in the chamber (11) of the casing (10) and has an outer edge and may further have at least one mounting hole (21), at least one through hole (22) and a cable slot (23). The at least one mounting hole (21) is defined in the heat sink (20) and faces forwards. The at least one through hole (22) is defined through the heat sink (20). The cable slot (23) is defined in the heat sink (20).

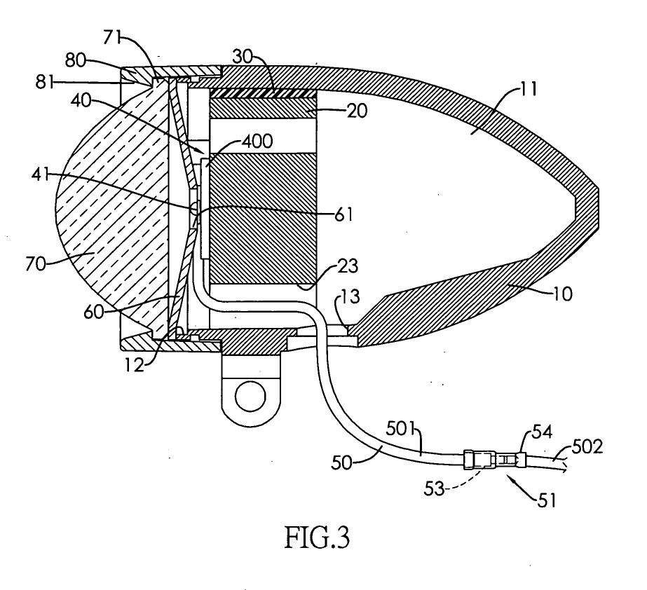

With further reference to FIG. 3, the thermal tape (30) may be resilient, has sufficiently high thermal conductivity, is mounted around and contacts the outer edge of the heat sink (20) and contacts the inner surface of the chamber (11) of the casing (10). The thermal tape (30) may be annular and have a gap (31) defined radially through the thermal tape (30) and corresponding to the cable slot (23) of the heat sink (20).

The LED module (40) is mounted detachably on and contacts the heat sink (20) and has a substrate (400), an LED (41), and at least one assembling hole (42) and at least one fastener (43).

The LED (41) is mounted on the substrate (400) of the LED module (40) and faces forward.

The at least one assembling hole (42) is defined through the substrate (400) and corresponds to the at least one mounting hole (21) of the heat sink (20).

The at least one fastener (43) is mounted respectively through the at least one assembling hole (42) and is mounted respectively in the mounting hole (21) of the heat sink (20) to securely hold the LED module (40) on the heat sink (20).

The cables (50) are connected electrically to the LED module (40), extend out of the cable outlet hole (13) of the casing (10) and each cable (50) has a stationary cable section (501), a detachable cable section (502) and a cable connector assembly (51). The stationary cable section (501) is connected securely and electrically to the substrate (400) and extends through the cable slot (23) of the heat sink (20) and out of the cable outlet hole (13) of the casing (10). The cable connector assembly (50) is connected between the stationary and detachable cable sections (501, 502), selectively detaches the detachable cable section (502) from the stationary cable section (501) and may have a first cable connector (53) and a second cable connector (54). The first cable connector (53) is mounted on the stationary cable section (501). The second cable connector (54) is mounted on the detachable cable section (502) and detachably engages the first cable connector (53).

The reflector (60) may be conical, is mounted in the front opening (12) of the casing (10) and has a concave surface and a lamp hole (61) and may further have at least one mounting protrusion (62). The concave surface reflects and concentrates light radiated from the LED (41). The lamp hole (61) is defined centrally through the reflector (60) and is mounted around the LED (41) so that the light from the LED (41) is corrected, guided and emitted as desired. The at least one mounting protrusion (62) is formed on and protrudes from the reflector (60) and is mounted respectively through the at least one through hole (22) of the heat sink (20) to align the reflector (60) with the heat sink (20).

The convex lens (70) is mounted in the front opening (12) in front of the reflector (60) to guide the light radiated from the LED (41). The convex lens (70) may have an annular flange (71) formed on and protruding radially from the convex lens (70).

The mounting collar (80) is mounted in the front opening (12) of the casing (10), securely holds the convex lens (70) and may have an inner surface and a hook (81) formed and protruding inward from the inner surface and hooking on the annular flange (71) of the convex lens (70) to securely hold the convex lens (70) in the casing (10).

When replacing the LED module (40), the mounting collar (80), convex lens (70) and reflector (60) are detached in turn and then the LED module (40) is disassembled by disengaged the cable connector assembly (51). Then, the heat sink (20) and thermal tape (30) is pulled down for installation of a new LED module (40). The stationary cable sections (501) on the substrate (400) of the new LED module (40) are mounted through the cable slot (23) of the heat sink (20) and out of the cable outlet hole (13) of the casing (10). Then, the second cable connectors on the detachable cable sections (502) respectively engage the first cable connectors on the stationary cable sections (501) of the new LED module (40). Then, the reflector (60), convex lens (70) and mounting collar (80) are assembled in turn to finish replacement of the LED module (40).

Because only the stationary cable sections (501) of the cables (50) are discarded and the detachable cable sections (502) are kept for repeated use during each replacement of the LED module (40), the lamp saves material cost of the cables (50). Furthermore, the thermal tape (30) having sufficient conductivity and contacting both the heat sink (20) and casing (10) effectively dissipates heat from the LED module to atmosphere through the casing (10) without using fans.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lamp comprising:
a casing having
a chamber defined in the casing and having an inner surface;
a front opening defined through the casing and communicating with the chamber; and
a cable outlet hole defined through the casing and communicating with the chamber;
a heat sink mounted in the chamber of the casing and having an outer edge;
a thermal tape mounted around and contacting the outer edge of the heat sink and contacting the inner surface of the chamber of the casing;
an LED module mounted detachably on and contacting the heat sink and having
a substrate; and
an LED mounted on the substrate and facing front;
two cables connected electrically to the LED module, extending out of the cable outlet hole and each cable having
a stationary cable section connected securely and electrically to the base;
a detachable cable section; and
a cable connector assembly connected between the stationary and detachable cable sections and selectively detaching the detachable cable section from the stationary cable section;
a convex lens mounted in the front opening of the casing; and
a mounting collar mounted in the front opening of the casing and securely holding the convex lens.

2. The lamp as claimed in claim 1, wherein
the heat sink further has at least one mounting hole defined in the heat sink;
the LED module further has at least one assembling hole defined through the substrate and corresponding to the at least one mounting hole of the heat sink; and
at least one fastener is mounted respectively through the at least one assembling hole of the substrate and mounted respectively in the mounting hole of the heat sink to securely hold the LED module on the heat sink.

3. The lamp as claimed in claim 1, wherein
the heat sink further has a cable slot defined in the heat sink;
the thermal tape has a gap defined radially through the thermal tape and corresponding to the cable slot; and
the stationary cable section of each cable extends through the cable slot of the heat sink and out of the cable outlet hole of the casing.

4. The lamp as claimed in claim 2, wherein
the heat sink further has a cable slot defined in the heat sink;
the thermal tape has a gap defined radially through the thermal tape and corresponding to the cable slot; and
the stationary cable section of each cable extends through the cable slot of the heat sink and out of the cable outlet hole of the casing.

5. The lamp as claimed in claim 1, wherein
the convex lens has an annular flange formed on and protruding radially from the convex lens; and
the mounting collar has an inner surface and a hook formed on and protruding inward from the inner surface and hooking on the annular flange of the convex lens to securely hold the convex lens in the casing.

6. The lamp as claimed in claim 2, wherein
the convex lens has an annular flange formed on and protruding radially from the convex lens; and
the mounting collar has an inner surface and a hook formed on and protruding inward from the inner surface and hooking on the annular flange of the convex lens to securely hold the convex lens in the casing.

7. The lamp as claimed in claim 3, wherein
the convex lens has an annular flange formed on and protruding radially from the convex lens; and
the mounting collar has an inner surface and a hook formed on and protruding inward from the inner surface and hooking on the annular flange of the convex lens to securely hold the convex lens in the casing.

8. The lamp as claimed in claim 4, wherein
the convex lens has an annular flange formed on and protruding radially from the convex lens; and
the mounting collar has an inner surface and a hook formed on and protruding inward from the inner surface and hooking on the annular flange of the convex lens to securely hold the convex lens in the casing.

9. The lamp as claimed in claim 1 further comprising a reflector mounted in the front opening of the casing between the LED module and the convex lens and having
a concave surface reflecting and concentrating light radiated from the LED; and
a lamp hole defined centrally through the reflector and mounted around the LED.

10. The lamp as claimed in claim 9, wherein
the heat sink further has at least one through hole defined through the heat sink; and
the reflector further has at least one mounting protrusion formed on and protruding from the reflector and mounted respectively through the at least one through hole of the heat sink to align the reflector with the heat sink.

11. The lamp as claimed in claim 1, wherein the cable connector assembly of each cable has
a first cable connector mounted on the stationary cable section; and
a second cable connector mounted on the detachable cable section and detachably engages the first cable connector.

12. The lamp as claimed in claim 7, wherein the cable connector assembly of each cable has
a first cable connector mounted on the stationary cable section; and
a second cable connector mounted on the detachable cable section and detachably engages the first cable connector.

13. The lamp as claimed in claim 8, wherein the cable connector assembly of each cable has
a first cable connector mounted on the stationary cable section; and
a second cable connector mounted on the detachable cable section and detachably engages the first cable connector.
